(19) United States
(12) Patent Application Publication
(10) Pub. No.: US 2017/0316878 A1
(43) Pub. Date: Nov. 2, 2017

(54) CAPACITIVE COMPONENT HAVING A HEAT-CONDUCTING CONNECTION ELEMENT

(71) Applicant: Robert Bosch GmbH, Stuttgart (DE)

(72) Inventor: Thomas PEUSER, Ludwigsburg (DE)

(21) Appl. No.: 15/518,309

(22) PCT Filed: Aug. 13, 2015
(86) PCT No.: PCT/EP2015/068629

§ 371 Date: Apr. 11, 2017

(30) Foreign Application Priority Data
Oct. 16, 2014 (DE) 10 2014 221 006.2

(51) Int. Cl. H01G 2/08; H01G 4/224; H01G 2/06; H01G 4/12; H01G 4/30; H01G 4/232

(52) U.S. Cl. CPC H01G 2/08; H01G 4/30; H01G 4/232; H01G 2/06; H01G 4/12; H01G 4/224

(57) ABSTRACT

The invention relates to a capacitive component having a ceramic capacitor. The capacitor has two electrical connections, each of which is formed as an electrically conductive layer, wherein the connections are arranged in particular in parallel at a distance to one another, and including the capacitor between same. The capacitor has at least one connection element with a securing foot, wherein at least one connection is connected to the connection element in an electrically conductive and integrally bonded manner. According to the invention, the component has a surface region formed without connections. The connection element, in particular the connection plate, has at least one section which extends parallel to the connectionless surface region of the capacitor, and which is connected to the surface region in a heat-conducting manner, and is designed to conduct heat away from the surface region, and to direct same to the securing foot. The capacitor has preferably one gap extending between the section and the surface region, said gap being at least partially or entirely filled with an electrically insulating heat-conducting medium.

### BACKGROUND OF THE INVENTION

The invention relates to a capacitive component comprising an in particular ceramically embodied capacitor. The capacitor has two electrical connections, wherein the electrical connections are embodied in each case as an electrically conductive layer, wherein the connections are spaced apart from one another—in particular in a parallel fashion—and enclose the capacitor between one another. The capacitor has at least one connection element, wherein at least one connection is electrically conductively and cohesively connected to the connection element, in particular a connection plate. The connection element preferably has a section forming a securing foot, in particular a standing foot.

In power circuits having capacitors, heat loss is also generated in the capacitors. The heat loss can generally be emitted to the ambient air surrounding the capacitor or be dissipated by convection.

### SUMMARY OF THE INVENTION

According to the invention, the component of the type mentioned in the introduction has a surface region embodied in a connectionless fashion. The connection element, in particular the connection plate, has at least one section which extends parallel to the surface region of the capacitor embodied in a connectionless fashion and which is thermally conductively connected to the surface region and is designed to dissipate heat from the surface region and to conduct it to the securing foot. The capacitor preferably has a gap extending between the section and the surface region, said gap being at least partly or completely filled with an electrically insulating heat-conducting medium. In this regard, heat loss that may be generated by the capacitor during operation may, additionally to or independently of the abovementioned convection, advantageously be emitted to the securing foot and from there to a printed circuit board. The securing foot is connected for example to a printed circuit board, preferably by means of a solder.

In one preferred embodiment, the cohesive connection between the connection element and the connection of the capacitor is formed by a soldering connection, a welding connection or an adhesive-bonding connection. As a result, advantageously, by means of the connection being electrically conductively connected to the connection element, heat loss generated by the capacitor can be dissipated via the soldering or welding connection, and in addition heat loss can be dissipated from the surface region embodied in a connectionless fashion via the heat-conducting medium to the section of the connection element, said section being embodied in particular as a lug. Specifically, an electrically conductive connection element is advantageously also embodied in a thermally conductive fashion in accordance with a Wiedemann-Franz law.

Preferably, a thermal conductivity of the connection element is designed to be greater than a thermal conductivity of the electrical connection. In this regard, heat loss may advantageously be dissipated from the surface region which is not covered by the connection. The connection element is preferably formed from sheet metal plate, in particular copper plate, aluminum plate, silver plate, nickel plate, for example alloy 42 comprising 42 percent by weight nickel and iron as main constituent. Further constituents may be carbon up to 0.05 percent by weight, manganese up to 0.8 percent by weight, phosphorus up to 0.025 percent by weight, sulfur up to 0.025 percent by weight, silicon up to 0.03 percent by weight, chromium up to 0.25 percent by weight, or aluminum up to 0.1 percent, or a combination thereof.

Preferably, the alloy of the connection plate is a nickel-containing alloy in accordance with the standard UNS K49100.

In one preferred embodiment, the capacitor is embodied in a parallelepipedal fashion, wherein the surface region has an extension direction of a surface normal vector that faces away from a standing surface or runs parallel to the standing surface. The surface normal vector faces away from the surface region, in particular a facet of the surface region, perpendicularly. The standing surface is formed for example by a circuit carrier, in particular a fiber-reinforced printed circuit board or a ceramic circuit carrier.

Preferably, a surface region of the component facing a standing surface is embodied in a manner free of the connection element. As a result, the connection element may be formed expediently in terms of outlay by angling a plate.

In this regard, a small structural height of the capacitive component may advantageously be formed. With further advantage, the section may thus advantageously be spaced apart from conductor tracks of a printed circuit board and thus not form any disturbing capacitances together with conductor tracks of the printed circuit board.

In one preferred embodiment, the section extends parallel to at least one electrode of the capacitor. In this regard, an additional capacitance may advantageously be formed by the section.

In one preferred embodiment, the capacitor has a connection element for each connection, wherein the sections of the connection elements extend jointly over the surface region. In this regard, a connection element having the same form may advantageously be used for each connection, such that the connection element and thus the capacitive component may be provided expediently in terms of outlay.

In one preferred embodiment, the section is formed by an angular lug, in particular sheet-metal lug. The lug, in particular the sheet-metal lug, is preferably integrally formed on the connection element, in particular connection plate. In this regard, the section may advantageously be produced by angling a sheet-metal strip. Preferably, the securing foot, in particular standing foot, is formed as an angular sheet-metal lug that is integrally formed on the connection element.

In one preferred embodiment, the connection element, in particular connection plate, has at least two sections which extend over mutually different facets of the surface region of the capacitor. In this regard, for example, a section, formed by a lug, may extend parallel to at least one electrode of the capacitor, wherein a further section, formed for example by an angular sheet-metal lug, extends transversely with respect to the section. Advantageously, the surface region of the capacitor may thus be covered almost completely by sheet-metal lugs of the connection elements. Preferably, the surface region of the capacitor embodied in a connectionless fashion is covered by the sheet-metal lugs to the extent of at least 80 percent, with further preference 90 percent, excluding a surface region facing a standing surface or a circuit carrier.

Preferably, the connection element has two sections extending parallel to one another, said sections enclosing and embracing a part of the capacitor between one another. As a result, a free surface region, in particular a surface region not covered by a circuit carrier or a standing surface, may be used for heat dissipation.

With further preference, the connection element has three sections embracing the surface region, wherein one section extends orthogonally with respect to the two further sections, which extend parallel to one another. In this regard, the capacitor may be virtually completely enclosed by the connection elements. As a result, the heat loss may be optimally dissipated.

In one preferred embodiment of the component, the heat-conducting medium is formed by a potting compound. In this regard, the heat-conducting medium may advantageously be introduced, expediently in terms of outlay, into a gap formed between the section and the surface region.

In one preferred embodiment, the potting compound comprises particles. The particles are preferably ceramic particles. Exemplary ceramic particles are, for example, particles composed of aluminum oxide, of titanium dioxide, of silicon nitride or of boron nitride.

In one preferred embodiment, the heat-conducting medium comprises a silicone gel. With further preference, the heat-conducting medium is formed by a silicone gel, in particular a particle-filled silicone gel. The heat-conducting medium may thus advantageously have a good electrical insulation capability. In one preferred embodiment, the heat-conducting medium comprises epoxy resin or is formed by epoxy resin, in particular particle-filled epoxy resin. The particles are ceramic particles, for example.

The connection element is preferably formed by a connection plate. In another embodiment, the connection element is formed by a connection element produced by means of metal casting, in particular injection molding.

The invention also relates to a method for dissipating heat loss from a ceramically embodied capacitor. In the method, the heat loss is conducted from a surface region of the capacitor embodied in a connection-free fashion to an electrically conductive connection element via a heat-conducting medium. The connection element is electrically conductively and cohesively connected, in particular adhesively connected by means of an electrically conductive adhesive or connected by soldering by means of a solder, to a connection of the capacitor.

### BRIEF DESCRIPTION OF THE DRAWINGS

The invention will now be described below with reference to figures and further exemplary embodiments.

FIG. 1 shows one exemplary embodiment of a capacitively embodied component having a capacitor, wherein connections of the capacitor are soldered in each case to a z-shaped connection element;

FIG. 2 shows one exemplary embodiment of a capacitively embodied component comprising a capacitor, wherein connections of the capacitor are soldered in each case to a connection element on which sheet-metal lugs are integrally formed, which cover a surface region of the capacitor embodied in a connectionless fashion.

### DETAILED DESCRIPTION

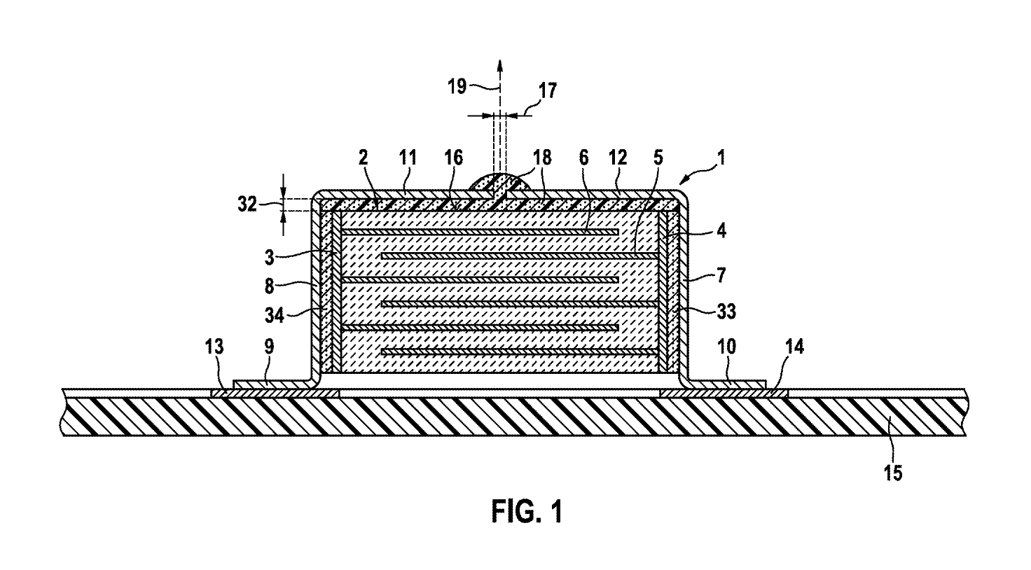

FIG. 1 shows one exemplary embodiment of a capacitively embodied component 1. The component 1 has a ceramically embodied capacitor 2. The capacitor 2 has two electrical connections extending parallel to one another, namely a connection 3 and a connection 4. The connections 3 and 4 are formed in each case by an electrically conductive layer, in particular a nickel-containing layer or a copper-containing layer. In this exemplary embodiment, the connection 3 is connected to a plurality of electrically conductive electrodes extending in each case into the interior of the capacitor 2, one electrode 6 of which is designated by way of example. In this exemplary embodiment, the connection 4 is connected to a plurality of electrodes extending in each case into the interior of the capacitor 2 and parallel to the electrodes, such as the electrode 6, which are connected to the connection 3. One electrode 5 of the electrodes connected to the connection 4 is designated by way of example. The electrodes are formed for example in each case by a metal layer, in particular nickel-containing layer or copper-containing layer.

The component 1 also has an electrically conductive connection element 7. The connection element 7 is formed by a connection plate and is electrically conductively and cohesively connected to the connection 4 by means of a connecting medium 33 for cohesive connection, in particular electrically conductive adhesive or solder. The electrically conductive adhesive comprises for example epoxy resin as matrix material and electrically conductive particles, for example silver particles and/or nickel particles.

The component 1 also has a connection element 8 embodied in an electrically conductive fashion, said connection element being formed by a connection plate in this exemplary embodiment. The connection element 8 is electrically conductively and cohesively connected to the connection 3 by means of a connecting medium 34 for cohesive connection.

The connection element 7 has an angular section 12 integrally formed on the connection element 7 and extending parallel to a surface region 16 of the capacitor 2. The connection element 8 has an angular section 11 integrally formed on the connection element 8 and extending parallel to the surface region 16. The sections 11 and 12 respectively face toward one another and enclose a gap 17 between one another. The sections 11 and 12 are thus electrically insulated from one another.

A gap 32 is formed between the section 11 of the connection element 8 and the surface region 16 and between the section 12 of the connection element 7 and the surface region 16. In this exemplary embodiment, the gap 32 is filled with a heat-conducting medium. In this exemplary embodiment, the heat-conducting medium 18 is formed by a potting compound, namely a particle-filled potting compound. The potting compound comprises epoxy resin as matrix material. In this exemplary embodiment, the particles are ceramic particles, for example aluminum oxide particles or nitride particles, in particular silicon nitride particles or boron nitride particles.

FIG. 1 also shows a surface normal vector 19 facing away from the surface region 16, in particular a facet of the capacitor 2, perpendicularly. In this exemplary embodiment, the capacitor 2 is embodied in a parallelepipedal fashion. FIG. 1 shows the component 1 and the capacitor 2 in a sectional illustration.

In this exemplary embodiment, the connection element 7 has a securing foot 10 embodied as a standing foot. The connection element 8 has a securing foot 9 embodied as a standing foot. The component 1 can thus be placed by the standing feet 9 and 10 onto a circuit carrier 15, in particular printed circuit board, and be soldered to the circuit carrier 15—for example in a reflow soldering furnace, by means of wave soldering or selectively. The securing foot 10 extending transversely with respect to the connection 4 is soldered to an electrically conductive layer 14 of the printed circuit board 15. An electrically conductive layer 13 connected to the printed circuit board 15 is soldered to the standing foot 9. The standing foot 9 extends transversely with respect to the connection 3, in particular a flat extent of the connection 3.

In this exemplary embodiment, the securing feet 9 and 10 face away from one another. In another embodiment—not illustrated in FIG. 1—the securing feet 9 and 10 may face toward one another.

The heat-conducting medium 18, a potting compound in this exemplary embodiment, may comprise for example a color pigment, in particular a red color pigment or a yellow color pigment. In this regard, advantageously, during a production process for producing the capacitive component 1, during quality control it is possible to check whether the gap 17 is filled with the heat-conducting medium 18, or whether the heat-conducting medium 18 can be seen through the gap 17 or can be detected by means of an optical detection device, for example.

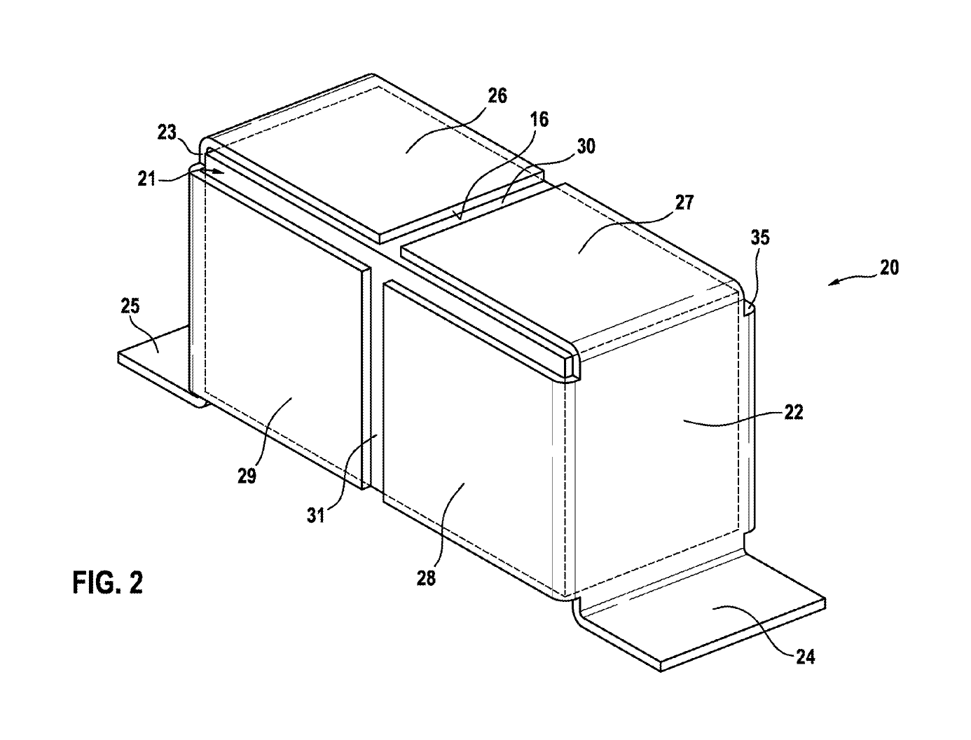

FIG. 2 shows one exemplary embodiment of a capacitively embodied component 20. The component 20 has a ceramically embodied capacitor 21. In this exemplary embodiment, the capacitor 21 is embodied in a parallelepipedal fashion. The connections of the capacitor 21, which respectively extend parallel to one another and which are not visible in the plan view of the component 20 as illustrated in FIG. 2, are connected by soldering by means of a solder or electrically conductively adhesively bonded by means of an electrically conductive adhesive in each case to a connection element, formed by a connection plate. The component 20 has a connection element 22 for a first connection of the capacitor 21 and a connection element 23 for the further connection of the capacitor 21. A section 27 and a section 28 are integrally formed on the connection element 22, said sections being embodied in each case as lugs angled from the connection element 22. In this exemplary embodiment, the connection element 22 is formed by a sheet-metal part, such that the lugs 27 and 28 are formed in each case by a sheet-metal lug. The sections 27 and 28 extend in each case in two spatial planes arranged perpendicularly to one another. A securing foot 24 is integrally formed on the connection element 22, said securing foot facing away from the capacitor 31 in this exemplary embodiment.

The connection element 23 is embodied like the connection element 22 and has two sections 26 and 29 embodied in each case as lugs, in particular sheet-metal lugs. The sections 26 and 29 extend in each case in two planes arranged perpendicularly to one another. The sections 29 and 28 extend in each case in the same plane and face toward one another. The sections 26 and 27 extend in each case in the same plane and face toward one another. A securing foot 25 is integrally formed on the connection element 23, said securing foot facing away from the capacitor 31 in this exemplary embodiment.

In addition to the sections 27, 28, 26 and 29, the component 20 may also have further sections, wherein the connection element 22 may have for example a further section extending parallel to the section 28, such that the further section and the section 28 enclose and embrace a part of the capacitor 21 between one another.

The component 20 may thus advantageously be enclosed by the connection elements 22 and 23. In this exemplary embodiment, a surface region which faces a printed circuit board or a standing surface of the component 20 and is embodied in a connection-free fashion is enclosed by no section, formed by a lug like the sections 27 and 28. As a result, advantageously, no parasitic capacitances can be formed between conductor tracks of a printed circuit board to be connected to the component 20 and the sections of the connection elements 22 and 23 which embrace the surface region 16 of the capacitor 21.

In this exemplary embodiment, the surface region 16 of the capacitor 21 comprises a facet 30 and a facet 31, which are oriented in each case perpendicular to one another. The facet 31 is almost completely covered by the sections 28 and 29 embodied in each case as a lug, and the facet 30 is almost completely covered by the sections 26 and 27 embodied in each case as a lug.

1. A capacitive component (1, 20) comprising a ceramic capacitor (2, 21), wherein the capacitor (2, 21) has two electrical connections (3, 4), wherein the electrical connections (3, 4) are each embodied as an electrically conductive layer, wherein the connections (3, 4) are spaced apart from one another and enclose the capacitor (2, 21) between one another, wherein at least one of the connections (3, 4) is electrically conductively and cohesively connected to a connection element (7, 8), wherein the connection element (7, 8) has a section forming a securing foot (9, 10, 24, 25),
characterized in that
the capacitor (2, 21) has a surface region (16, 30, 31) embodied in a connectionless fashion, and the connection element (7, 8, 22, 23) has at least one section (11, 12, 26, 27, 28, 29) which extends parallel to the surface region (16, 30, 31) and which is thermally conductively connected to the surface region (16, 30, 31) and is configured to dissipate heat from the surface region (16, 30, 31) and to conduct the heat to the securing foot (9, 10, 24, 25), wherein a gap (32) extending between the section (11, 12, 26, 27, 28, 29) and the surface region (16, 30, 31) is at least partly or completely filled with an electrically insulating heat-conducting medium (18).

2. The component (1, 20) as claimed in claim 1,
characterized in that
the capacitor (2, 21) is embodied in a parallelepipedal fashion, and the surface region (16, 30, 31) has an extension direction of a surface normal vector (19) that faces away from a standing surface or runs parallel to the standing surface.

3. The component (1, 20) as claimed in claim 1,
characterized in that
the capacitor has a connection element (7, 8, 22, 23) for each connection (3, 4), wherein the sections (11, 12, 26, 27, 28, 29) extend jointly over the surface region (16, 30, 31).

4. The component (1, 20) as claimed in claim 1,
characterized in that
the section (11, 12, 26, 27, 28, 29) is formed by an angular lug that is integrally formed on the connection element (7, 8, 22, 23).

5. The component (1, 20) as claimed in claim 1,
characterized in that
the connection element (7, 8, 22, 23) has at least two sections (11, 12, 26, 27, 28, 29) which extend over mutually different facets of the surface region (16, 30, 31) of the capacitor (2, 21).

6. The component (1, 20) as claimed in claim 1,
characterized in that
the heat-conducting medium (18) is formed by a potting compound.

7. The component (1, 20) as claimed in claim 6,
characterized in that
the potting compound comprises particles.

8. The component (1, 20) as claimed in claim 6,
characterized in that
the heat-conducting medium comprises a silicone gel.

9. The component (1, 20) as claimed in claim 6,
characterized in that
the heat-conducting medium (18) comprises an epoxy resin.

10. A method for dissipating heat loss from a ceramically embodied capacitor (2, 21), wherein the heat loss is conducted from a surface region (16, 30, 31) of the capacitor (2, 21) embodied in a connection-free fashion to an electrically conductive connection element (7, 8, 22, 23) via a heat-conducting medium (18), wherein the connection element (7, 8, 22, 23) is electrically conductively and cohesively connected by one section to a connection (3, 4) of the capacitor (2, 21).

12. The component (1, 20) as claimed in claim 6,
characterized in that
the potting compound comprises ceramic particles.
